(19) United States
(12) Patent Application Publication
(10) Pub. No.: US 2005/0198429 A1
(43) Pub. Date: Sep. 8, 2005

(54) Multilayer system and clock control method

(75) Inventors: Sachiko Hoshi, Kanagawa (JP); Kyoichi Nariai, Kanagawa (JP)

Correspondence Address: FOLEY AND LARDNER;SUITE 500, 3000 K STREET NW, WASHINGTON, DC, 20007, US

(73) Assignee: NEC Electronics Corporation

(21) Appl. No.: 11/054,952

(22) Filed: Feb. 11, 2005

(30) Foreign Application Priority Data
Mar. 2, 2004 (JP) 2004-057608

(51) Int. Cl. G06F 13/00

(52) U.S. Cl. 710/316

(57) ABSTRACT

The multilayer system includes a multilayer switch which allows simultaneous processing of commands from a plurality of masters. The multilayer switch has a switch master portion corresponding to a master and a switch slave portion corresponding to a slave. The switch master portion outputs to a clock generator a clock request signal for supplying a clock signal to a switch slave portion corresponding to the slave specified by an address signal of the slave included in an access signal from a corresponding master. The clock generator supplies a clock signal to a switch slave portion corresponding to a slave to be accessed in response to the clock request signal.

### BACKGROUND OF THE INVENTION

1. Field of the Invention

The present invention relates to a multilayer system including a multilayer switch which allows simultaneous processing of commands from a plurality of masters and a clock control method in the multilayer system.

2. Description of Related Art

Recent mobile phones have become multifunctional, having not only telephone functions but also internet connection functions, camera functions and so on. Further, in order to realize downsizing, weight saving, and reduction in power consumption, System on Chip (SoC) technology which incorporates multiple functions on one chip has been developed.

Such mobile phones require high speed, simultaneous processing. Thus, a multilayer switch which allows simultaneous access to a plurality of slaves has been proposed.

Use of the multilayer switch permits to carry out a process of writing image data from a camera into a given memory region and a process of reading the image data stored in the memory and displaying it on a screen at the same time.

FIG. 5 shows a configuration example of a system including a multilayer switch. A plurality of master modules (hereinafter simply as “masters”) 11 and slave modules (“slaves”) 13 are connected to a multilayer switch module (“multilayer switch”) 12. The multilayer switch 12 includes a switch master portion 120 connected to each master 11 and a switch slave portion 121 connected to each slave 13.

A clock generator 14 constantly supplies clock signals to the masters 11, the multilayer switch 12, and the slaves 13.

FIG. 6 shows a layout example of circuits on one chip. For example, an M0 which is the master 11 such as a CPU is placed at a corner. Other modules such as SWM0, SWS0, S0, and S1 are arranged on the chip in a dispersed manner. A clock signal is constantly supplied to each module from the clock generator 14.

Each module receives a clock signal and operates, thereby consuming power. A drive buffer 15 is placed in a line between each module and the clock generator 14 in order to prevent deterioration of a signal waveform or control timing. If a line length from each module to the clock generator 14 is long, many drive buffers 15 are placed as shown in FIG. 6. The drive buffer 15 also consumes power due to a through current when the output of a transistor changes from high to low or from low to high.

Japanese Unexamined Patent Publication No. 2003-141061 discloses a technique that supplies power to only some of a plurality of buses in a normal bus configuration. However, these buses do not have a multilayer switch function that allows simultaneous processing of commands from a plurality of masters.

As described above, the present invention has recognized that a conventional multilayer system requires a large amount of power since it supplies clock signals to all of the masters, slaves, and multilayer switch.

### SUMMARY OF THE INVENTION

According to one aspect of the invention, there is provided a multilayer system that includes a plurality of masters; a plurality of slaves; a multilayer switch disposed between the masters and the slaves, simultaneously processing commands from the plurality of masters, and having switch master portions corresponding to the masters and switch slave portions corresponding to the slaves; and a clock generator supplying a clock signal to the masters, the slaves, and the multilayer switch, wherein, upon occurrence of an access from the master to the slave, the clock generator starts supplying a clock signal to a switch slave portion corresponding to the accessed slave. In this invention, upon occurrence of the access to the slave by the master, the clock generator starts supplying a clock signal to the switch slave portion corresponding to the accessed slave. Thus, the clock signal is supplied only when needed, thereby reducing power consumption.

According to another aspect of the invention, there is provided a multilayer system that includes a plurality of masters; a plurality of slaves; a multilayer switch disposed between the masters and the slaves, simultaneously processing commands from the plurality of masters, and having switch master portions corresponding to the masters and switch slave portions corresponding to the slaves; and a clock generator supplying a clock signal to the masters, the slaves, and the multilayer switch, wherein the switch master portion outputs to the clock generator a clock request signal for supplying a clock signal to a switch slave portion corresponding to a slave specified by an address signal included in an access signal from a corresponding master, and the clock generator supplies a clock signal to a switch slave portion corresponding to a slave to be accessed in response to the clock request signal output from the switch master portion. In this invention, the clock generator supplies a clock signal to the switch slave portion corresponding to the accessed slave in response to a clock request signal output from the switch master portion. Thus, the clock signal is supplied only when needed, thereby reducing power consumption.

The present invention provides a multilayer system with low power consumption and a clock control method in the multilayer system.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of a multilayer system of this invention;

FIG. 2 is a diagram to describe the configuration of a switch slave in the multilayer system of this invention;

FIG. 3 is a timing chart in the multilayer system of this invention;

FIG. 4 is a block diagram of another multilayer system of this invention;

FIG. 5 is a block diagram of a conventional multilayer system; and

FIG. 6 is a diagram to describe a problem to be solved in a conventional technique.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

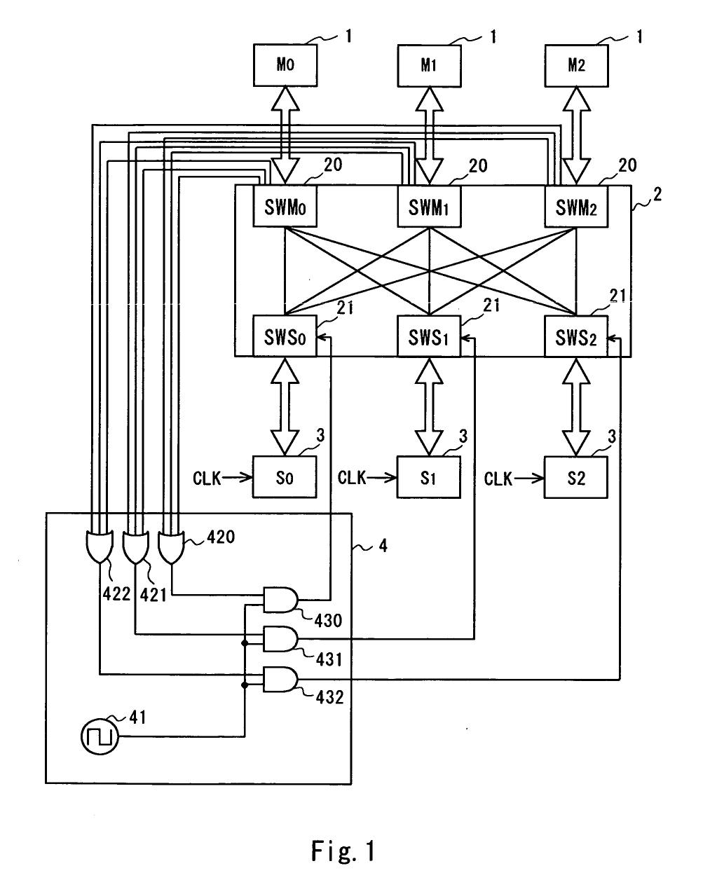

FIG. 1 shows a block diagram of a multilayer system of the present invention. The multilayer system includes a plurality of masters 1 (M0, M1, M2), a plurality of slaves 3 (S0, S1, S2), a multilayer switch 2 for the masters 1 and the slaves 3, and a clock generator 4 supplying a clock signal to each module.

The master 1 is a module that controls the system, such as Central Processor Unit (CPU), Digital Signal Processor (DSP), image rotating device, camera image processing circuit, Liquid Crystal Display (LCD) controller, and so on. In this example, the M0 is a CPU that always operates. The M1 and M2 are modules that operate as needed according to instructions from the M0.

The multilayer switch 2 allows simultaneous processing of commands from a plurality of masters. The multilayer switch 2 is an interconnection bus system that allows use of a parallel access path between a plurality of masters and slaves in the system. The bus system is realized by use of a more complex interconnection matrix and provides advantages such as increase in architecture options and in the entire bus bandwidth. The multilayer switch 2 is offered by ARM Ltd. as Advanced High-performance Bus (AHB), AHB-Lite®, for example.

The slave 3 is a module that is controlled by the master 1. The slave 3 includes a memory, a register, a timer, a serial interface circuit, and so on.

The configuration of the multilayer switch 2 is described in detail below. The multilayer switch 2 has switch master portions 20 (SWM0, SWM1, SWM2) connected to each of the masters 1 (M0, M1, M2), and switch slave portions 21 (SWS0, SWS1, SWS2) connected to each of the slaves 3.

The switch master portion 20 has the function that determines which slave 3 is to be connected in response to the access from the master 1 and sends an access request to the switch slave portion 21 corresponding to the slave 3 to be connected. Further, the switch master portion 20 generates a clock request signal to the clock generator 4 to supply a clock signal to the switch slave portion 21 corresponding to the slave 3 to be accessed.

The key function of the switch slave portion 21 is to arbitrate the access signals from each switch master portion 20, select one access and make a connection to the selected slave 3. The switch slave portions 21 perform clock control independently from each other. Specifically, no clock is supplied to the switch slave portion 21 in normal times, and a clock signal is supplied thereto upon occurrence of an access to the corresponding slave 3 from the master 1.

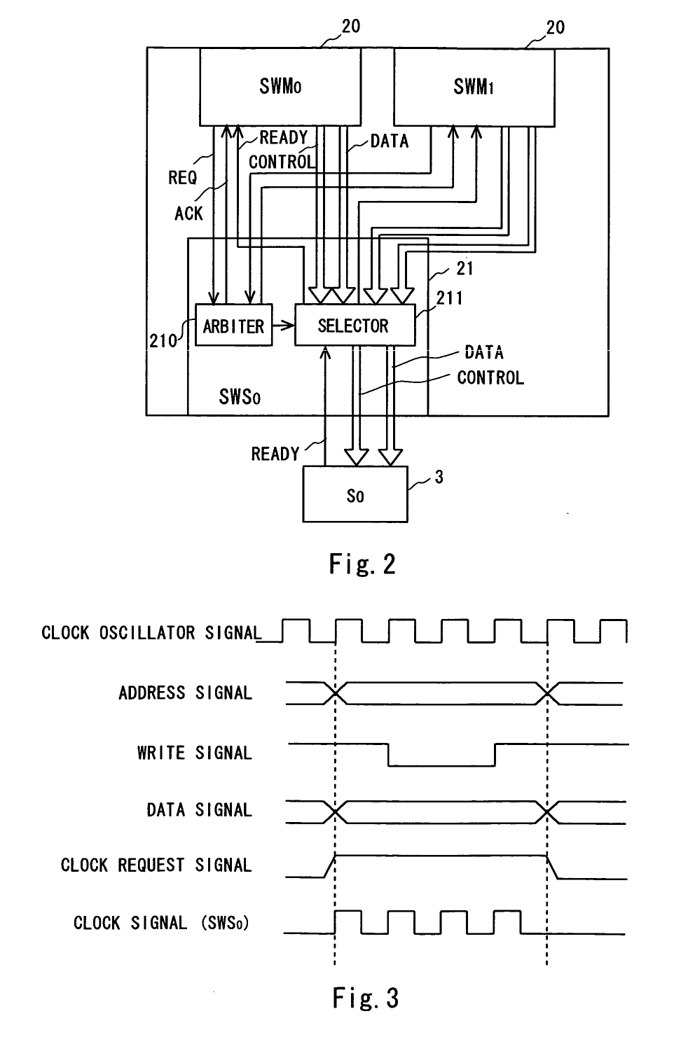

As shown in FIG. 2, the switch slave portion 21 includes an arbiter 210 and a selector 211. Lines for a request signal REQ, an acknowledge signal ACK, a ready signal READY, a control signal CONTROL, a data signal DATA and so on are formed between the switch slave portion 21 and each switch master portion 20. Lines for a ready signal READY, a control signal CONTROL, a data signal DATA and so on are formed between the switch slave portion 21 and the slave 3.

Though FIG. 2 illustrates two switch master portions 20 (SWM0, SWM1) only, the same number of switch master portions 20 as the number of masters are placed in practice, and the arbiter 210 and the selector 211 need to perform adjustment and selection processing, thus having a complicated configuration. The power consumption of the switch slave portions 21 is therefore not negligible. Further, FIG. 2 illustrates basic elements only, and other elements are added normally.

In FIG. 1, the clock generator 4 generates a clock signal supplied to each module. The clock generator 4 starts or stops supplying the clock signal to a corresponding module according to a clock request signal.

The clock generator 4 includes a clock signal oscillator 41, OR circuits 420, 421, 422, and AND circuits 430, 421, 432. The clock signal oscillator 41 outputs a clock oscillation signal. The clock signal oscillator 41 may be placed outside the chip. The OR circuit 420, 421, and 422 are connected to the switch master portions 20 (SWS0, SWS1, SWS2) by lines. Clock request signals from the switch master portions 20 flow through these lines. For example, the OR circuits 420 receive the clock request signals from each of the SWM0, SWM1, and SWM2. Upon input of the clock request signal from any of the switch master portions 20, an ON signal is input to the AND circuit 430.

In the AND circuits 430, 431, and 432, one input is connected to the corresponding OR circuit 420, 421, or 422, and the other input is connected to the clock signal oscillator 41. The output of the AND circuit 430 and so on is connected to the corresponding switch slave portion 21. Since the clock signal oscillator 41 constantly supplies a clock signal to the AND circuit 430 and so on, the AND circuit 430 and so on which receives the ON signal from the OR circuit 420 and so on outputs the clock signal generated in the clock signal oscillator 41. The clock signal is then input to the connected switch slave portion 21.

In this example, a clock signal is constantly supplied to the masters 1, the switch master portions 20, and the slaves 3 from the clock generator 4.

One example of the operation of the multilayer system of this embodiment is described hereinafter. The case where the M0, which is the master 1, accesses the S0, which is the slave 3, is described hereinafter with reference to the system block diagram of FIG. 1 and the timing chart of FIG. 3.

As shown in FIG. 3, the clock signal oscillator 41 constantly supplies a clock signal to the masters 1, the switch master portions 20, and the slaves 3. However, since the clock generator 4 does not receive a clock request signal from the switch master portion 20 and thus the clock request signal is off, no clock signal is supplied to the switch slave portions 21.

Upon occurrence of an access from the M0 to the S0, the M0 outputs an address signal of an access destination (S0 in this case) and a control signal such as a read/write signal to the SWM0, which is the switch master portion 20 of the multilayer switch 2.

The SWM0 determines which slave 3 is to be accessed based on the address signal from the M0. Further, the SWM0 generates a clock request signal that requests to supply a clock signal to SWS0 which is the switch slave portion 21 corresponding to S0 which is the slave 3 to be accessed, and outputs the signal to the clock generator 4. Then, the SWM0 outputs the access destination address signal and control signal to the SWS0.

The clock generator 4 receives the clock request signal output from the SWM0. Since the clock request signal requests to supply a clock signal to the SWS0 in this example, it is input to the OR circuit 420. The OR circuit 420 outputs an ON signal to the AND circuit 430 in response to input of the clock request signal. The AND circuit 430 outputs the clock signal from the clock signal oscillator 41 to the SWS0 in response to input of the ON signal. The clock signal is thereby supplied to the SWS0 so that the SWS0 is ready for operation.

The SWS0 outputs the access destination address signal and the control signal from the SWM0 to the S0, which is the slave 3 to be accessed. Receiving the address signal and the control signal, the S0 starts exchanging a data signal with the M0.

After that, when the SWM0 recognizes the completion of the data exchange between the M0 and the S0, the SWM0 stops outputting the clock request signal in order to stop supply of the clock signal to the SWS0, and the clock request signal is thereby turned off. In the clock generator 4, in response to the stop of the clock request signal, the input signal to the AND circuit 430 from the OR circuit 420 changes from the ON signal to OFF signal, and the AND circuit 430 thereby stops outputting the signal from the clock signal oscillator 41. This stops the supply of the clock signal to the SWS0.

Though the example of FIG. 3 stops the supply of the clock signal to the SWS0 in the same timing as the stop of the output of the clock request signal from the SWM0, it is not limited thereto, and the clock may be stopped after a certain clock cycles.

The above example takes the SWS0 as the switch slave portion 21 for which clock signal supply control is performed, it is not limited thereto, and the control operation is the same for other switch slave portions 21 such as SWS1 and SWS2.

As described in the foregoing, this embodiment supplies no clock signal to the switch slave portion 21 in normal times and supplies the clock signal thereto only when needed, thereby reducing power consumption.

### Second Embodiment

The first embodiment controls the supply of a clock signal to the switch slave portion 21. The second embodiment controls the supply of a clock signal to the switch slave portion 21 and also to the slave 3.

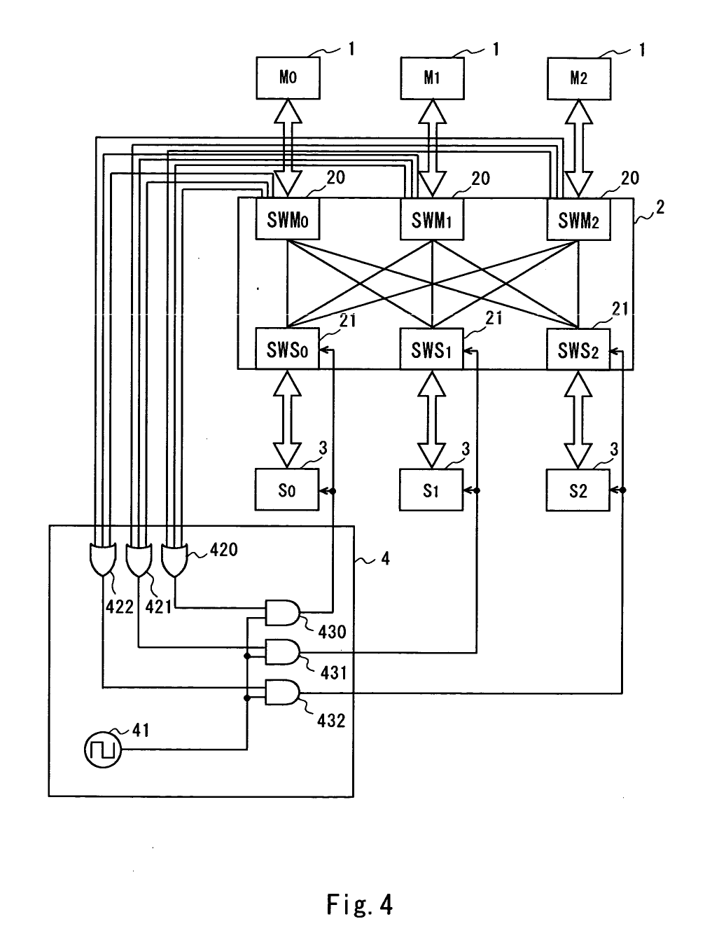

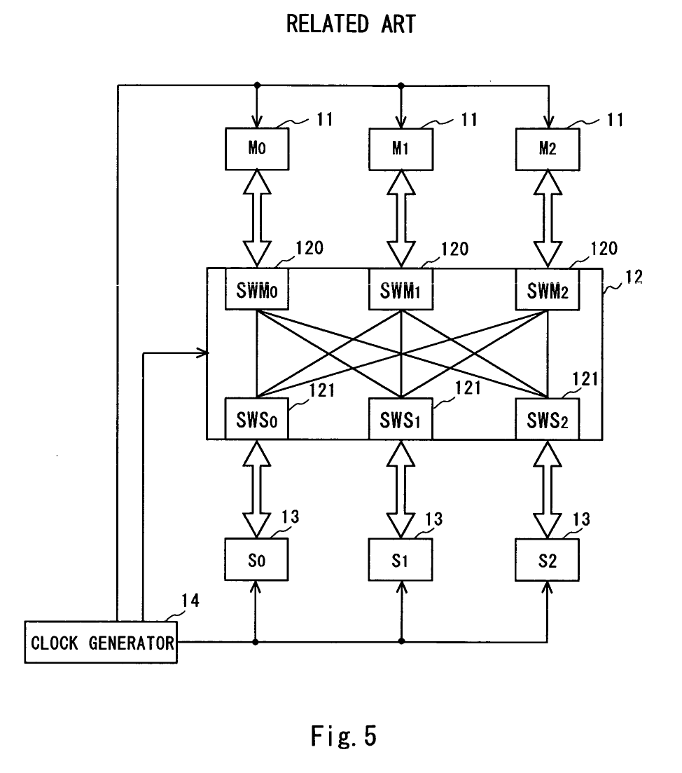

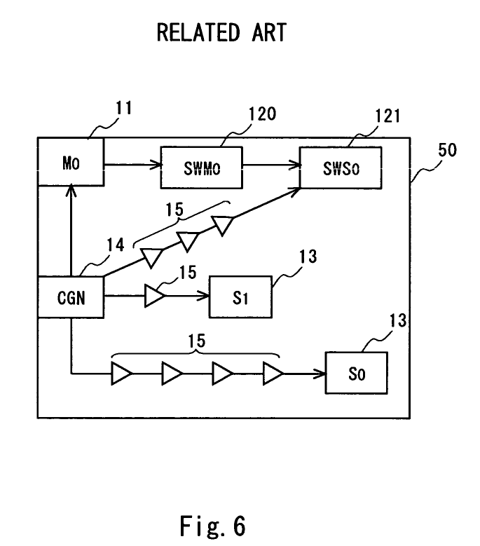

FIG. 4 is a block diagram of a multilayer system of the second embodiment. As shown in FIG. 4, the line for supplying a clock signal from the clock generator 4 is connected not only to each switch slave portion 21 but also to each slave 3. The other elements are the same as in the first embodiment shown in FIG. 1.

In this configuration, the clock generator 4 supplies a clock signal not only to the switch slave portion 21 but also to the slave 3 in response to the clock request signal from the switch master portion 20. Further, the clock generator 4 stops the clock supply not only to the switch slave portion 21 but also to the slave 3 when the clock request signal from the switch master portion 20 is turned off.

As described in the foregoing, this embodiment supplies no clock signal to the switch slave portion 21 and to the slave 3 in normal times and supplies the clock signal thereto only when needed, thereby further reducing power consumption compared to the first embodiment.

It is apparent that the present invention is not limited to the above embodiment that may be modified and changed without departing from the scope and spirit of the invention.

1. A multilayer system comprising:
a plurality of masters;
a plurality of slaves;
a multilayer switch disposed between the masters and the slaves, simultaneously processing commands from the plurality of masters, and comprising switch master portions corresponding to the masters and switch slave portions corresponding to the slaves; and
a clock generator supplying a clock signal to the masters, the slaves, and the multilayer switch,
wherein, upon occurrence of an access from the master to the slave, the clock generator starts supplying a clock signal to a switch slave portion corresponding to the accessed slave.

2. The multilayer system of claim 1, wherein, upon occurrence of an access from the master to the slave, the clock generator starts supplying a clock signal to the accessed slave and a switch slave portion corresponding to the accessed slave.

3. The multilayer system of claim 1, wherein at least one master of the plurality of masters constantly receives a clock signal from the clock generator.

4. The multilayer system of claim 1, wherein the multilayer system is incorporated into a mobile phone.

5. A multilayer system comprising:
a plurality of masters;
a plurality of slaves;
a multilayer switch disposed between the masters and the slaves, simultaneously processing commands from the plurality of masters, and comprising switch master portions corresponding to the masters and switch slave portions corresponding to the slaves; and
a clock generator supplying a clock signal to the masters, the slaves, and the multilayer switch,
wherein the switch master portion outputs to the clock generator a clock request signal for supplying a clock signal to a switch slave portion corresponding to a slave specified by an address signal included in an access signal from a corresponding master, and
the clock generator supplies a clock signal to a switch slave portion corresponding to a slave to be accessed in response to the clock request signal output from the switch master portion.

6. The multilayer system of claim 5, wherein
the switch master portion outputs to the clock generator a clock request signal for supplying a clock signal to a slave specified by an address signal included in an access signal from a corresponding master, and a switch slave portion corresponding to the slave, and
the clock generator supplies a clock signal to a slave to be accessed and a switch slave portion corresponding to the slave to be accessed in response to the clock request signal output from the switch master portion.

7. The multilayer system of claim 5, wherein at least one master of the plurality of masters constantly receives a clock signal from the clock generator.

8. The multilayer system of claim 5, wherein the multilayer system is incorporated into a mobile phone.

9. A clock control method in a multilayer system including a multilayer switch disposed between a master and a slave, simultaneously processing commands from a plurality of masters, and having a switch master portion corresponding to the master and a switch slave portion corresponding to the slave; and a clock generator supplying a clock signal at least to the multilayer switch, comprising:
detecting an access to a specific slave; and
in response to detection of an access to the specific slave, starting in the clock generator supply of a clock signal to a switch slave portion corresponding to the accessed slave.

10. The clock control method of claim 9, wherein, upon detection of an access from the master to the slave, the clock generator starts supplying a clock signal to the accessed slave and a switch slave portion corresponding to the accessed slave.

11. The clock control method of claim 9, wherein at least one master of the plurality of masters constantly receives a clock signal from the clock generator.

12. A clock control method in a multilayer system including a multilayer switch disposed between a master and a slave, simultaneously processing commands from a plurality of masters, and having a switch master portion corresponding to the master and a switch slave portion corresponding to the slave; and a clock generator supplying a clock signal at least to the multilayer switch, the method comprising:
outputting from the switch master portion to the clock generator a clock request signal for supplying a clock signal to a switch slave portion corresponding to a slave specified by an address signal included in an access signal from a corresponding master, and
supplying from the clock generator a clock signal to a switch slave portion corresponding to a slave to be accessed in response to the clock request signal output from the switch master portion.

13. A clock control method of claim 12, wherein
the switch master portion outputs to the clock generator a clock request signal for supplying a clock signal to a slave specified by an address signal included in an access signal from a corresponding master, and a switch slave portion corresponding to the slave, and
the clock generator supplies a clock signal to a slave to be accessed and a switch slave portion corresponding to the slave to be accessed in response to the clock request signal output from the switch master portion.

14. The clock control method of claim 12, wherein at least one master of the plurality of masters constantly receives a clock signal from the clock generator.
